(19) United States
(12) Patent Application Publication
(10) Pub. No.: US 2015/0076320 A1
(43) Pub. Date: Mar. 19, 2015

(54) ELECTRONIC MULTIPLIER POROUS GLASS PLATE AND DETECTOR

(71) Applicant: HOYA CORPORATION, Tokyo (JP)

(72) Inventors: Takashi Fushie, Tokyo (JP); Hajime Kikuchi, Tokyo (JP); Fuyuki Tokanai, Yamagata-shi (JP)

(21) Appl. No.: 14/387,512

(22) PCT Filed: Mar. 25, 2013
(86) PCT No.: PCT/JP2013/058561

§ 371 Date: Sep. 23, 2014

(30) Foreign Application Priority Data
Mar. 23, 2012 (JP) 2012-068365

(51) Int. Cl. H01J 43/04

(52) U.S. Cl. CPC H01J 43/04
USPC 250/207

(57) ABSTRACT

An electronic multiplier porous glass plate used for a detector that measures ionized electrons by utilizing an electron avalanche multiplication in a gas is presented. The plate has a plurality of through holes provided on a plate-like member so as to be arranged two-dimensionally, wherein the plate-like member is formed by a photosensitive crystallized glass obtained by crystallizing a photosensitive glass, to realize a thinner glass plate and finer through holes.

### TECHNICAL FIELD

The present invention relates to an electronic multiplier porous glass plate and a detector configured by using the electronic multiplier porous glass plate.

### DESCRIPTION OF RELATED ART

In recent years, a detector utilizing electron avalanche multiplication by a gas electronic multiplier (abbreviated as “GEM” hereafter), is known as the detector for detecting an electromagnetic wave or a particle beam. Generally GEM has an electronic multiplier substrate in which a plurality of through holes are formed on a plate-like film member made of polyimide, etc., having a thickness of about 50 μm so as to penetrate its front and rear surfaces, with both surfaces of the film member coated with copper. Then, the electronic multiplier substrate is configured to measure ionized electrons in a detected gas by applying potential difference between two electrodes using a copper thin film coating both surfaces of the film member as an electrode, creating a strong electric field in the pores of the plurality of through holes, then causing avalanche multiplication by this electric field, and increasing the number of the ionized electrons so as to be grasped as a signal (for example, see patent document 1).

However, the film member made of polyimide, etc., is used for the GEM having the abovementioned structure, thus involving a problem that heat resistance, smoothness, and rigidity, etc., are low, and outgas is easily generated. Therefore, regarding the detector for detecting the particle beam or the electromagnetic wave, there is proposed the use of a substrate made of lead-free soda-lime glass (for example see patent document 2) or the use of a substrate made of an inorganic material such as a heat-resistant glass, etc., (for example see patent document 3) as a base material of the electronic multiplier substrate.

### PRIOR ART DOCUMENT

### Patent document

Patent document 1: Japanese Patent Laid Open Publication No. 2006-302844
Patent document 2: Patent Publication No. 4058359
Patent document 3: Japanese Patent Laid Open Publication No. 2009-301904

### SUMMARY OF THE INVENTION

### Problem to be Solved by the Invention

As the base material of the electronic multiplier substrate for the use of detecting the particle beam or the electromagnetic wave, not the film member made of polyimide, etc., but the glass substrate is preferably used from a viewpoint of heat resistance, etc., as described above. However, in the glass substrate such as a soda-lime-glass and a heat resistant glass, etc., the limit of the plate thickness is about 250 μm at smallest, and it is extremely difficult to realize a similar thickness as the thickness of the film member made of polyimide, etc. This is because if the plate thickness is smaller than about 250 μm, breakage, etc., occurs due to insufficient strength. It can be considered that the glass substrate (called an “electronic multiplier porous glass plate” hereafter) which is the base material of the electronic multiplier substrate is preferably formed to be thin, unless the breakage, etc., occurs. One of the reasons is as follows: electrons are multiplied in the pores of the through holes during electron avalanche multiplication. At this time, if the electronic multiplier porous glass plate has a large plate thickness, and each through hole has a small hole diameter, there is a high possibility that the electrons are adhered to a wall surface of the hole before passing through the through holes, and as a result, there is a possibility that a sufficient multiplication degree (gain) of electrons cannot be obtained. In other words, a sufficient gain can be obtained during avalanche multiplication, even if the potential difference applied between electrodes is not increased more than necessary, by realizing a thinner electronic multiplier porous glass plate without generating the breakage, etc., and suppressing an inner wall area of the through hole. Therefore, such a thin electronic multiplier porous glass plate is extremely suitable for the use of the detector utilizing the electron avalanche multiplication.

Further, regarding the electronic multiplier porous glass plate for the use of detecting the particle beam or the electromagnetic wave, a plurality of through holes penetrating the front and rear surfaces of the plate are preferably configured so that the hole diameter and an arrangement pitch is set to be finer. This is because the hole diameter and the arrangement pitch of the through holes have direct influence on a detection power, and therefore finer hole diameter and finer arrangement pitch are required for improving the detection power. However, it can be considered that the through holes are formed on the glass material such as the soda-lime-glass and the heat-resistant glass, by machining using a fine powder injection method, etc. However, in this case, there is a limit in forming the through hole with a hole diameter of about 100 μm and at an arrangement pitch of about 150 μm, and it is extremely difficult to perform further finer machining. As described above, it is also difficult to produce a thinner glass material such as a soda-lime glass and a heat resistant glass, etc., and this point is also an obstacle for realizing the finer hole diameter and finer arrangement pitch of the through holes.

Therefore, an object of the present invention is to provide an electronic multiplier porous glass plate and a detector capable of thinning a plate and decreasing a hole diameter of each through hole even if the formation material is a glass.

### Means for Solving the Problem

In order to achieve the above-described object, the present invention is provided.

In order to achieve the object, inventors of the present invention examine the finer hole diameter and arrangement pitch of the through holes. In order to achieve the finer hole diameter and arrangement pitch of the through holes, it is effective to use a fine machining technique used in a semiconductor manufacturing process for example. Therefore, the inventors of the present invention focus on a photosensitive glass. The photosensitive glass is configured so as to apply selective etching only to a photosensitive portion by exposure using hydrogen fluoride (HF), and is the material to which the fine machining can be applied while taking advantage of the properties of the glass.

However, it is difficult to realize the thinner photosensitive glass even if the fine machining is possible. This is because even in a case of the photosensitive glass, breakage, etc., occurs due to insufficient strength, similarly to the soda-lime-glass and the heat resistant glass, etc. Namely, the photosensitive glass is an amorphous solid similarly to the soda-lime-glass and the heat resistant glass, etc., and it can be considered that it is not necessarily easy to produce a thinner glass in a state of such an amorphous solid similarly to the film member made of polyimide, etc.

In this point, as a result of strenuous efforts by the inventors of the present invention, it is found that even in a case of using a fragile glass, a sufficient strength enough to realize the thinner plate can be obtained while using the fine machining technique used in the semiconductor manufacturing process, if not the photosensitive glass itself but the photosensitive crystallized glass obtained by crystallizing the photosensitive glass is used. The photosensitive crystallized glass called here is the glass obtained by precipitating a fine crystal evenly in the glass by applying heat treatment to the photosensitive glass, and set in a polycrystalline state in which crystallization is completely advanced, and has an excellent mechanical property compared with the amorphous solid.

The present invention is provided based on the abovementioned new knowledge by the inventors of the present invention.

According to a first aspect of the present invention, there is provided an electronic multiplier porous glass plate used for a detector that measures ionized electrons by utilizing an electron avalanche multiplication in a gas, the plate having a plurality of through holes arranged on a plate-like member two-dimensionally,

wherein the plate-like member is formed by a photosensitive crystallized glass obtained by crystallizing a photosensitive glass.

According to a second aspect of the present invention, there is provided the electronic multiplier porous glass plate of the first aspect, wherein the photosensitive crystallized glass has a bending strength of larger than 150 MPa in a non-formation state of the through holes.

According to a third aspect of the present invention, there is provided the electronic multiplier porous glass plate of the first aspect or the second aspect, wherein each of the plurality of through holes has a hole diameter of 100 μm or less.

According to a fourth aspect of the present invention, there is provided the electronic multiplier porous glass plate of any one of the first to third aspects, wherein the plurality of through holes are arranged at an arrangement pitch of 400 μm or less.

According to a fifth aspect of the present invention, there is provided the electronic multiplier porous glass plate of any one of the first to fourth aspects, wherein the plate-like member is formed having a plate thickness of 500 μm or less.

According to a sixth aspect of the present invention, there is provided a detector, including:

an electronic multiplier porous glass plate having a plurality of through holes provided on a plate-like member two-dimensionally, wherein the plate-like member is formed by a photosensitive crystallized glass obtained by crystallizing a photosensitive glass;

an electrode having conductive layers formed on front and rear surfaces of the electronic multiplier porous glass plate, and forming an electric field in the through hole by applying a potential difference between the front and rear surfaces; and

a chamber for disposing the electronic multiplier porous glass plate and the electrode in a gas,

wherein ionized electrons are measured by utilizing an electron avalanche multiplication that occurs by the electric field formed in the through holes in the gas.

### Advantage of the Invention

According to the present invention, even in a case of using a glass as a formation material of the electronic multiplier porous glass plate, the electronic multiplier porous glass plate can be thinned, and the hole diameter and the arrangement pitch of the through holes formed on the electronic multiplier porous glass plate can be made finer.

### BRIEF DESCRIPTION OF THE DRAWINGS

FIG. 1 is an explanatory view showing a schematic constitutional example of a detector according to an embodiment of the present invention.

FIG. 2 is an explanatory view showing a typical property of a photosensitive crystallized glass and a photosensitive glass according to an embodiment of the present invention.

FIG. 3 is an explanatory view showing an example of a manufacturing procedure of an electronic multiplier porous glass plate according to an embodiment of the present invention.

FIG. 4 is an explanatory view showing a planar shape of an essential part of the electronic multiplier porous glass plate according to example 1.

FIG. 5 is an explanatory view showing an electric field conversion state according to example 1.

FIG. 6 is an explanatory view showing an example of electron avalanche multiplication according to example 1.

FIG. 7 is an explanatory view showing other example of the electron avalanche multiplication according to example 1.

FIG. 8 is an explanatory view showing a planar shape of an essential part of an electronic multiplier porous glass plate according to example 2.

FIG. 9 is an explanatory view showing an electric field conversion state according to example 2.

FIG. 10 is an explanatory view showing an example of an electron avalanche multiplication according to example 2.

FIG. 11 is an explanatory view showing other example of the electron avalanche multiplication according to example 2.

FIG. 12 is an explanatory view showing a test setup state according to example 3.

FIG. 13 is an explanatory view showing a gain property during electron avalanche multiplication according to example 3.

FIGS. 14A and 14B are explanatory views showing an energy resolution of an energy spectrum according to example 4.

FIGS. 15A, 15B and 15C are explanatory views showing a drift test according to example 5.

FIG. 16 is an explanatory view showing a peak channel of the energy spectrum and an energy resolution according to example 6.

FIG. 17 is an explanatory view showing an irradiation position dependency of the peak channel of the energy spectrum according to example 7.

FIG. 18 is an explanatory view showing a gain property during electron avalanche multiplication according to example 8.

### DETAILED DESCRIPTION OF THE INVENTION

Embodiments of the present invention will be described hereafter, based on the drawings.

In these embodiments, explanation is given according to the following items.

1. Schematic structure of a detector
2. Structure of an electronic multiplier porous glass plate
3. Manufacturing procedure of the electronic multiplier porous glass plate
4. Measurement procedure of ionized electrons in a detector
5. Effect of this embodiment
6. Modified example, etc.

<1. Schematic Structure of a Detector>

The schematic structure of a detector according to this embodiment will be described first.

The detector is configured to measure ionized electrons by utilizing the electron avalanche multiplication in a detection gas, thus detecting the particle beam or the electromagnetic wave.

The following phenomenon is called the “electron avalanche multiplication” utilized by the detector: when free electrons collide with gas molecules in a strong electric field, new electrons are knocked-out, which is accelerated in the electric field, and the new electrons further collide with another molecules, thus increasing the number of electrons at an accelerated pace. The detector utilizing the electron avalanche multiplication includes a capillary gas proportional counter (CGPC) for example, and in this embodiment, the unit that causes the electron avalanche multiplication using GEM is called the detector.

Wherein “GEM” is the multiplier configured to create a strong electric field in each pore of the through holes in the electronic multiplier substrate, and causing the electron avalanche multiplication to occur by the electric field, in a state that the electronic multiplier substrate having a plurality of two-dimensionally arranged fine through holes is disposed in a detection gas. The electronic multiplier substrate may be a single plate substrate or a multiple plate substrate in which a plurality of sheets are layered.

The “particle beam” to be detected by the detector includes alpha rays, beta rays, proton beams, heavy charged particle beams, electron beams (beams for accelerating electrons in an accelerator regardless of a nuclear decay), neutron beams, and cosmic rays, etc. Also, the “electromagnetic wave” includes a radio wave (low frequency wave, ultralong wave, long wave, medium wave, short wave, ultrashort wave, microwave), lights (infrared ray, visible rays, UV-rays), X-rays, and gamma rays, etc. Out of these rays, the ray to be detected can be set to a desired ray by suitably selecting the kind of the detection gas and the created strength, etc., of the electric field.

The detector of this embodiment as described above, namely the detector that detects the particle beam or the electromagnetic wave by utilizing the electron avalanche multiplication by GEM, is specifically configured as described below.

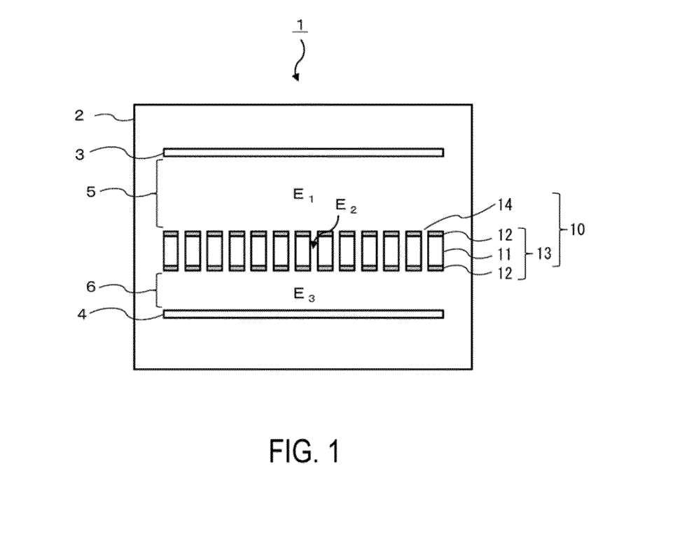

FIG. 1 is an explanatory view showing a schematic constitutional example of the detector of this embodiment.

A detector 1 shown in the figure includes a drift electrode 3 and a readout electrode 4 inside of a chamber 2 filled with a specific kind of detection gas, and also includes an electronic multiplier substrate 10 disposed between the drift electrode 3 and the readout electrode 4. The electronic multiplier substrate 10 is configured to realize a function as GEM by causing the electron avalanche multiplication to occur, wherein a plurality of through holes 14 are two-dimensionally arranged in a lamination body 13 in which conductive layers 12 are formed on both sides of plate-like members 11. Each of the plurality of through holes 14 has a circular shape when observing the electronic multiplier substrate 10 in planar view, and arranged at a specific interval provided between them. Also, inside of the chamber 2 is configured so that the particle beam or the electromagnetic wave to be detected, can be incident thereon from outside.

A specific voltage is applied to the drift electrode 3 and the readout electrode 4 in the chamber 2 from a power source not shown. Also, a specific voltage is applied to each conductive layer 12 on both surfaces of the electronic multiplier substrate 10 from the power source not shown, by a function of each conductive layer 12 as an electrode. Due to such an application of voltage from the power source, electric field E1 is generated in an area between the drift electrode 3 and the electronic multiplier substrate 10 (called a “drift region” hereafter) 5, and electric field E3 is generated in an area between the electronic multiplier substrate 10 and the readout electrode 4 (called an “inductance region” hereafter). Further, electric field E2 is generated in the pore of through hole 14 of the electronic multiplier substrate 10. Then, electric field E2 is converged in the pore of the through hole 14, and the electron avalanche multiplication occurs by accelerating the electrons that enter into the pore. The detector 1 is configured to measure the electrons multiplied by the electron avalanche multiplication, using the readout electrode 4, and output a measurement result thereof through an electric circuit, etc., for reading a signal not shown, which is connected to the readout electrode 4.

In the detector 1 having the abovementioned structure, it can be considered that each plate-like member 11 constituting the electronic multiplier substrate 10 is formed using a glass material, because the plate-like member is the base material of the electronic multiplier substrate 10, and in this case as well, the glass material capable of realizing a thinner plate and finer through hole 14 is preferably selected. Therefore, in the detector 1 of this embodiment, the electronic multiplier substrate 10 is formed using an electronic multiplier porous glass plate as described below.

<2. Structure of an Electronic Multiplier Porous Glass Plate>

The structure of the electronic multiplier porous glass plate of this embodiment will be described next.

The electronic multiplier porous glass plate is configured to have a plurality of two-dimensionally arranged through holes 14 on the plate-like member 11 made of a glass as a formation material, namely configured to have glass capillaries bundled in parallel regularly and formed into a plate-shape, and particularly configured so that the electron avalanche multiplying function can be caused in the gas. The electronic multiplier substrate 10 is constituted by forming conductive layers 12 that function as electrodes on front and rear surfaces of the electronic multiplier porous glass plate.

The electronic multiplier porous glass plate of this embodiment has a large characteristic in a point that it is formed by the photosensitive crystallized glass obtained by crystallizing the photosensitive glass.

The “photosensitive glass” is the glass obtained by containing a slight quantity of Au, Ag, and Cu as photosensitive metals, and further containing CeO₂ as a sensitizer, in SiO₂—Li₂O—Al₂O₃-based glass.

In the photosensitive glass, oxidation-reduction reaction occurs by irradiation of UV-rays, thereby generating metal atoms. Further, the metal atoms are aggregated to form a colloid by heating, and Li₂O.SiO₂ (meta silicic acid lithium) crystal grows, with such a colloid as a crystal core. Li₂O.SiO₂ (metal silicic acid lithium) precipitated here is easily dissolved into HF, and there is a difference of about 50 times in a dissolution rate, compared with a glass portion which is not irradiated with UV-rays. By utilizing such a difference of the dissolution rate, selective etching is enabled, and a fine workpiece can be formed without using a mechanical machining.

For example, “PEG3 (product name)” produced by HOYA Corporation can be given as such a photosensitive glass.

Further, the “photosensitive crystallized glass” is the glass obtained by precipitating a fine crystal evenly in the glass, by applying heat treatment to the photosensitive glass (heat treatment under different condition from the condition for applying fine processing to the photosensitive glass). The crystal precipitated here has excellent chemical durability, unlike the crystal of Li₂O.SiO₂ (meta silicic acid lithium). Accordingly, the photosensitive crystallized glass is set in a polycrystalline state in which crystallization is completely advanced, and therefore has an advantage of having excellent mechanical characteristic compared with the photosensitive glass which is an amorphous solid.

For example, “PEG3C (product name)” produced by HOYA Corporation can be given as such a photosensitive crystallized glass.

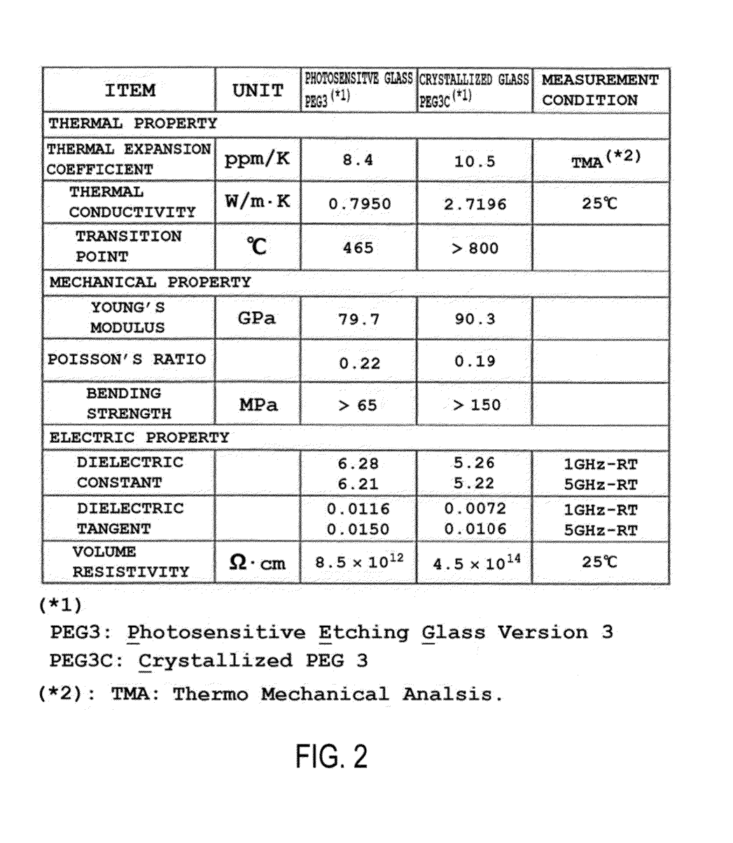

FIG. 2 shows a typical characteristic of “PEG3C” which is the photosensitive crystallized glass, together with a typical characteristic of “PEG3” which is the photosensitive glass as a base of the photosensitive crystallized glass.

As is clarified from the figure, the photosensitive crystallized glass has an excellent mechanical characteristic compared with the photosensitive glass. Specifically, it is found that bending strength of “PEG3” is larger than 65 MPa, and meanwhile bending strength of “PEG3C” is larger than 150 MPa, and therefore “PEG3C” has a larger bending strength.

Accordingly, for example when the electronic multiplier porous glass plate is formed by “PEG3C”, the electronic multiplier porous glass plate has the bending strength larger than 150 MPa in a non-formation state of the through holes 14.

Further, “PEG3C” which is the photosensitive crystallized glass has a volume resistivity of about 10¹⁴ Ωm. Accordingly, it can be said that “PEG3C” is hardly charged due to low insulation resistance, compared with polyimide having the volume resistivity of 10¹⁵ Ωm or more.

Further, the electronic multiplier porous glass plate of this embodiment has a plurality of two-dimensionally arranged through holes 14 at a specific interval having the circular shape in planar view. The plurality of through holes 14 have a hole diameter of 100 μm or less (for example, 30 to 100 μm, preferably 30 to 50 μm) at an arrangement pitch of 400 μm or less (for example, 50 to 400 μm, preferably 50 to 360 μm). Note that lower limit values of the hole diameter and the pitch are not particularly limited, but a size that allows electrons to pass through and can be formed by a manufacturing procedure described later is the lower limit value.

Further, the electronic multiplier porous glass plate of this embodiment is formed having the plate thickness of 500 μm or less. If the plate thickness is 400 μm or less, it can be said that the electronic multiplier porous glass plate of this embodiment is suitable for the use of the electronic multiplier substrate 10. However, the plate thickness is preferably set to 300 μm or less, and more preferably set to about 100 to 150 μm. Particularly, if the plate thickness is about 100 to 150 an aspect ratio (ratio of the hole diameter and a hole length) of the through hole 14 can be prevented from becoming excessively large, in consideration of the matter that the through hole 14 has the hole diameter of 100 μm or less.

<3. Manufacturing Procedure of the Electronic Multiplier Porous Glass Plate>

The manufacturing procedure of the electronic multiplier porous glass plate configured as described above, will be described next.

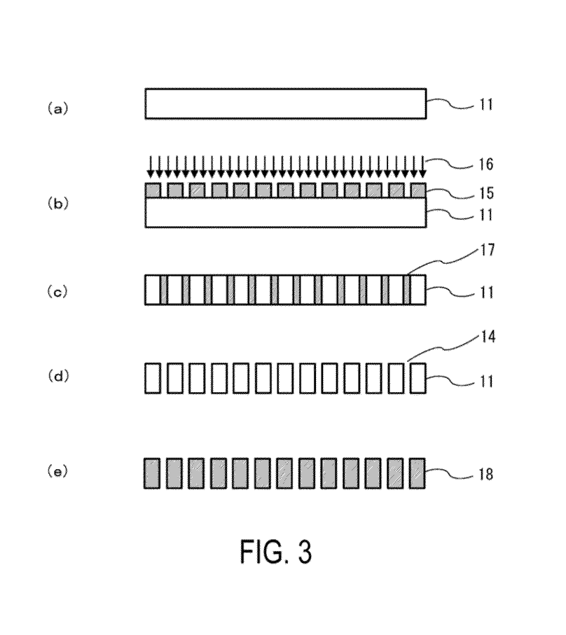

FIG. 3 is an explanatory view showing an example of the manufacturing procedure of the electronic multiplier porous glass plate of this embodiment.

In manufacturing the electronic multiplier porous glass plate, first, as shown in FIG. 3 (a), a flat-shaped plate-like member 11 is prepared, which is formed into a desired outer shape (for example, rectangular shape of 30 mm×300 mm) and into a desired thickness, using the photosensitive glass such as “PEGS”.

Then, as shown in FIG. 3(b), a photomask 15 with a desired pattern formed thereon is overlapped on the prepared plate-like member 11, and the plate-like member 11 is irradiated with UV-ray 16 through the photomask 15. Thus, the oxidation-reduction reaction occurs at an UV irradiation site of the plate-like member 11, thus generating metal atoms.

Thereafter, heat treatment is applied to the plate-like member 11 after UV irradiation at a temperature of 450 to 600° C. for example. Then, as shown in FIG. 3 (c), in the plate-like member 11, the metal atoms generated by UV irradiation are aggregated to form a colloid, and Li₂O.SiO₂ (meta silicic acid lithium) crystal grows, with such a colloid as a crystal core.

Li₂O.SiO₂ (meta silicic acid lithium) precipitated here is easily dissolved into HF (hydrogen fluoride), and there is a difference of about 50 times in a dissolution rate, compared with a glass portion which is not irradiated with UV-rays. Therefore, after crystal growth by heat treatment, as shown in FIG. 3(d), etching is applied to the plate-like member 11 using HF. Thus, etching for removing a crystal portion 17 precipitated by heat treatment, namely selective etching utilizing the difference of dissolution rate in a case of using HF, is applied to the plate-like member 11, and as a result, fine through holes 14 with approximately the same precision as the pattern of the photomask 15 can be formed on the plate-like member 11 without using the mechanical machining.

The plate-like member 11 thus obtained after forming the through holes 14, is still made of the photosensitive glass such as “PEG3”, etc., as the formation material. Therefore, as shown in FIG. 3(e), further heat treatment is applied to the plate-like member 11 with the through holes 14 formed thereon, after forming the through holes 14 by selective etching. The heat treatment at this time is performed under a different condition from the condition of the previous heat treatment performed for forming the through holes 14. Specifically, heat treatment is performed at a temperature exceeding 1000° C. for example. Thus, the plate-like member 11 is set in a polycrystalline state in which fine crystals are evenly precipitated in the glass with excellent chemical durability and crystallization is completely advanced, unlike the case of the previously performed heat treatment. This is the state corresponding to the photosensitive crystallized glass such as “PEG3C” obtained by crystallizing the photosensitive glass such as “PEGS”. Namely, an electronic multiplier porous glass plate 18 in which a plurality of through holes 14 are two-dimensionally arranged on the photosensitive crystallized glass such as “PEG3C” is obtained by performing heat treatment again under the different condition from the condition of the previously performed heat treatment. The electronic multiplier porous glass plate 18 thus obtained is made of the photosensitive crystallized glass and set in the polycrystalline state in which crystallization is completely advanced, and therefore has an advantage that it is excellent in the mechanical characteristic, compared with a case that it is made of the photosensitive glass which is an amorphous solid (for example, see FIG. 2).

After the electronic multiplier porous glass plate 18 is manufactured by the abovementioned procedure, the conductive layers 12 made of the material having excellent conductivity such as Cu (copper), are formed on front and rear surfaces of the electronic multiplier porous glass plate 18 respectively, by sputtering for example, to thereby constitute the electronic multiplier substrate 10 for the use of the detector 1.

<4. Measurement Procedure of Ionized Electrons in a Detector>

Specific explanation is given, with reference to FIG. 1, for a procedure of measuring the ionized electrons by the detector 1, thereby detecting the particle beam or the electromagnetic wave, in a case that the detector 1 is constituted using the electronic multiplier substrate 10 formed using the electronic multiplier porous glass plate 18 of this embodiment as a base. Wherein, explanation is given as follows, with a case that X-ray to be detected, as an example.

Inside of the chamber 2 of the detector 1 is filled with a specific kind of detection gas (for example mixed gas of Ar+CF₄). Further, different magnitude of voltage is applied to the drift electrode 3, the readout electrode 4, and the conductive layer 12 of the electronic multiplier substrate 10, so as to read the electrons generated in the drift region 5 and draw the generated electrons toward the readout electrode 4, to thereby generate electric fields E1, E2, and E3. Namely, voltage is applied to the drift electrode 3, the readout electrode 4, and the conductive layer 12 of the electronic multiplier substrate 10 respectively, so as to apply potential difference in such manner that power of drawing electrons becomes larger toward the readout electrode 4.

When X-rays are incident into the chamber 2 in this state, the gas is ionized by the incident X-rays in the drift region 5 in the chamber 2, and electrons are generated by such an ionization effect. At this time, since electric field E1 is formed in the drift region 5, the generated electrons are drawn toward the electronic multiplier substrate 10, and are likely to pass through the through holes 14 of the electronic multiplier substrate 10.

However, high electric filed is caused by the formation of the electric field E2. Therefore, speed of the electrons passing through the through holes 14 is accelerated by such a high electric field, and a kinetic energy of the electrons is increased, thereby applying energy to other surrounding electrons, and discharging the electrons by a new ionization action. This process is repeated so that the electrons are multiplied, and as a result, the electrons are multiplies like an avalanche. Namely, when the electrons are passed through the pores of the through holes 14, the electron avalanche multiplication occurs.

The electrons multiplied by the electron avalanche multiplication, are drawn toward the readout electrode 4 by electric field E3 formed in the inductance region. Then, electron number is read out as a signal by the readout electrode. The readout electrode 4 thus configured to readout the signal, is divided into small areas. Therefore, the area where the electrons are measured, can be specified.

Depending on gas species in the chamber 2, light is excited in conjunction with ionization of the electrons in the drift region 5, or on behalf of the ionization of the electrons, and the excited light is multiplied in the pores of the through holes 14 in some cases. In this case, the electrons can be measured as an imaging signal by using an imaging device such as CCD (Charge Coupled Device) as the readout electrode 4.

<5. Effect of this Embodiment>

According to the electronic multiplier porous glass plate 18 and the detector 1 described in this embodiment, the following effect can be obtained.

In this embodiment, the electronic multiplier porous glass plate 18 is formed by the photosensitive crystallized glass. Therefore, even when the glass being a fragile material is used as a constitutional material of the electronic multiplier substrate 10, a sufficient strength capable of realizing a thinner plate, etc., can be obtained while utilizing a fine machining technique (specifically a pattern transfer technique using the photomask 15) used for a semiconductor manufacturing process. Namely, the electronic multiplier porous glass plate 18 can be thinned, which is not realized by the glass material such as a soda-lime glass and a heat resistant glass, etc., and further a finer hole diameter and finer arrangement pitch of the through holes 14 can be realized, which cannot be realized by the film member such as polyimide and the glass material such as a soda-lime glass and the heat resistant glass.

Accordingly, by thinning the electronic multiplier porous glass plate 18 constituting the electronic multiplier substrate 10, the detector 1 of this embodiment can obtain a sufficient gain (for example, electronic multiplication factor exceeding 10⁴) during electron avalanche multiplication, even if not unnecessarily increasing the potential difference applied between conductive layers 12 in the electronic multiplier substrate 10, and even if there is only one electronic multiplier substrate 10 in the chamber 2. This is because if the electronic multiplier porous glass plate 18 is thin in the plate thickness, an inner wall area of each through hole 14 can be reduced, compared with a case that it is thick in the plate thickness, and therefore there is a high possibility that the electrons can pass through the through holes 14 without adhering to the wall surface in the pore. Namely, for example if the electronic multiplier porous glass plate 18 has a large plate thickness and a small hole diameter of the through hole 14, there is a high possibility that the electrons may adhere to the wall surface in the pore before passing through the through hole 14, resulting in failing in obtaining a sufficient gain. However, such a problem is solved by the detector 1 of this embodiment and the sufficient gain can be obtained. It should be noted that the plate thickness of the electronic multiplier porous glass plate 18 must be set in consideration of the fact that probably gain reduction occurs during electron avalanche multiplication, if the electronic multiplier porous glass plate 18 is excessively thinned. It can be considered that this is because gap width required for the electron avalanche multiplication (distance between conductive layers 12 on front and rear surfaces of the substrate) becomes small.

Further, the detector 1 of this embodiment can effectively suppress a charge-up of the electronic multiplier substrate 10. This is because by reducing an inner wall area of the through hole 14 by thinning the electronic multiplier porous glass plate 18 constituting the electronic multiplier substrate 10, adhesion of ions to the wall surface in the pore of the through hole 14 can be suppressed similarly to the electrons. Namely, even when the photosensitive crystallized glass is used as the electronic multiplier porous glass plate 18, having a higher insulation resistance than that of other glass, charge-up can be effectively suppressed by realizing a thinner plate. Further, the photosensitive crystallized glass constituting the electronic multiplier porous glass plate 18, is hardly charged due to low insulation resistance compared with polyimide, etc., and from this point as well, charge-up hardly occurs.

The detector 1 of this embodiment can also realize finer hole diameter and finer arrangement pitch of the through holes 14, by thinning the electronic multiplier porous glass plate 18 constituting the electronic multiplier substrate 10. This is because aspect ratio of the through hole 14, etc., can be prevented from being excessively large. Specifically, if the electronic multiplier porous glass plate 18 has a plate thickness of about 100 to 150 μm, pixel number per unit area of the electronic multiplier porous glass plate 18 can be easily set to 10000 pixels/cm² or more. Here, the “pixel number per unit area” means the number of through holes formed per unit area of the electronic multiplier porous glass plate 18. Namely, one through hole 14 corresponds to one pixel. Thus, in the detector 1 of this embodiment, the number of the through holes 14 formed on the electronic multiplier porous glass plate 18 has a direct influence on a detection power. Accordingly, the detector 1 of this embodiment is capable of improving the detection power (resolution of the detector 1) by realizing a finer hole diameter and finer arrangement pitch of the through holes 14 while thinning the electronic multiplier porous glass plate 18. In this point as well, the detector 1 of this embodiment is extremely suitable for the use of the detector utilizing the electron avalanche multiplication. In addition, by utilizing a pattern transfer technique using the photomask 15, not only smaller pore and narrower pitch, etc., of the through holes 14 can be realized, but also higher evenness of the diameter and pitch, etc., of each through hole 14 can be maintained. In this point as well, the detector 1 of this embodiment is extremely effective for improving the detection power.

Also, as already described in this embodiment, by using an imaging device such as CCD, etc., as the readout electrode 4 for example, if the gain is secured during electron avalanche multiplication and the detection power is improved, an imaging detector having an excellent position resolution power for detecting not only the X-rays given as an example in this embodiment, but also the lights in a range of visible lights to X-rays, can be constructed by utilizing the electron avalanche multiplication. In this case, it is extremely useful to increase the pixel number per unit area in the electronic multiplier porous glass plate 18 as described above, to realize high resolution.

Further in this embodiment, the electronic multiplier porous glass plate 18 is formed by the photosensitive crystallized glass having the bending strength of 150 MPa or larger in the non-formation state of the through hole 14. Namely, since the electronic multiplier porous glass plate 18 is formed by the photosensitive crystallized glass, it has the bending strength larger than 150 MPa, namely the bending strength that cannot be obtained by neither the glass material such as a soda-lime glass and a heat-resistant glass, nor the photosensitive glass such as “PEG3”, etc. Accordingly, by utilizing such an excellent mechanical characteristic, generation of a damage such as a breakage, etc., can be prevented, even in a case of responding to thinning the plate and making a finer pore of the through hole 14. In addition, by utilizing the excellent mechanical characteristic, the electronic multiplier porous glass plate 18 of a large area, for example having a rectangular shape of 300 mm×300 mm, can be formed, which cannot be realized conventionally.

Also, according to this embodiment, the hole diameter of each through hole 14 is set to 100 μm or less, and the arrangement pitch of the through holes 14 is set to 400 μm or less in the electronic multiplier porous glass plate 18. Namely, finer through holes 14 are formed on the electronic multiplier porous glass plate 18, with each hole diameter thinned so that it cannot be formed by mechanical machining such as a fine powder injection method, and it cannot be formed unless the fine machining technique (specifically pattern transfer technique using the photomask 15) is used, which is used for the semiconductor manufacturing process. Accordingly, the finer through holes 14 are extremely suitable for improving the detection power of the detector 1.

Particularly, by setting the hole diameter of the through hole 14 to 100 μm or less, the following effect is obtained. If the hole diameter of the through hole 14 is set to be smaller (specifically 100 μm or less), the arrangement pitch of the through holes 14 can also be made finer accordingly, and therefore as a result, the detection power can be improved.

Also, by setting the arrangement pitch of the through holes 14 to 400 am or less, the following effect can be obtained. When the arrangement pitch of the through holes 14 is set to 400 μm or less, specifically it can be considered that the arrangement pitch is set to 50 to 400 μm for example. This is because if the arrangement pitch of the through holes 14 is less than 50 μm, the plate thickness of the electronic multiplier porous glass plate must be set to excessively thin. If the arrangement pitch of the through holes 14 is 50 to 400 μm, the through hole 14 having the hole diameter of 30 to 350 μm can be formed, and therefore sufficient detection power and gain can be obtained, and detection efficiency can be maintained.

Further in this embodiment, the electronic multiplier porous glass plate 18 is formed, having the plate thickness of 500 μm or less. With the plate thickness of 400 μm or less, the electron avalanche multiplication can be caused if the electronic multiplier porous glass plate 18 is used for the electronic multiplier substrate 10. However, in order to obtain a sufficient gain and suppress the charge-up during electron avalanche multiplication, it is effective to thin the electronic multiplier porous glass plate 18. Therefore, the plate thickness of the electronic multiplier porous glass plate 18 is preferably set to 300 μm or less. Meanwhile, if the plate thickness of the electronic multiplier porous glass plate 18 is set to be excessively thin, the electron avalanche multiplication does not occur, and there is a high possibility that electric discharge occurs. Therefore, it can be considered that the plate thickness of the electronic multiplier porous glass plate 18 is further preferably set to about 100 to 150 μm. For example, when the plate thickness of the electronic multiplier porous glass plate 18 is set to about 100 to 150 μm, the electronic multiplication factor exceeding 10⁴ can be realized, although depending on the gas species and an application voltage.

<6. Modified Example, Etc.>

The embodiments of the present invention have been described above. However, the abovementioned disclosure content shows exemplary embodiments. Namely, a technical range of the present invention is not limited to the abovementioned exemplary embodiments.

For example, the abovementioned embodiments show a case of only one electronic multiplier substrate 10 in the chamber 2. However, a plurality of electronic multiplier substrates 10 may be provided in the chamber 2. Although the detector 1 including a plurality of electronic multiplier substrates 10 involves a problem of complicating an apparatus structure, compared with a case of only one electronic multiplier substrate 10, the gain can be easily increased during electron avalanche multiplication.

Further, the abovementioned embodiments show a case that the electronic multiplier porous glass plate 18 is formed having the through holes 14, each having the hole diameter of 100 μm or less and arrangement pitch of 400 μm or less. However, the hole diameter and the arrangement pitch of the through holes 14 are not necessarily limited to such ranges. For example, even when the plate thickness of the electronic multiplier porous glass plate 18 is 400 μm, and each hole diameter of the formed through holes 14 is 200 μm, and the arrangement pitch thereof is 400 μm, the electron avalanche multiplication can be caused by constituting the electronic multiplier substrate 10 using the electronic multiplier porous glass plate 18.

### EXAMPLE

The present invention will be specifically described, by giving examples. However, of course the present invention is not limited to the following examples.

### Example 1

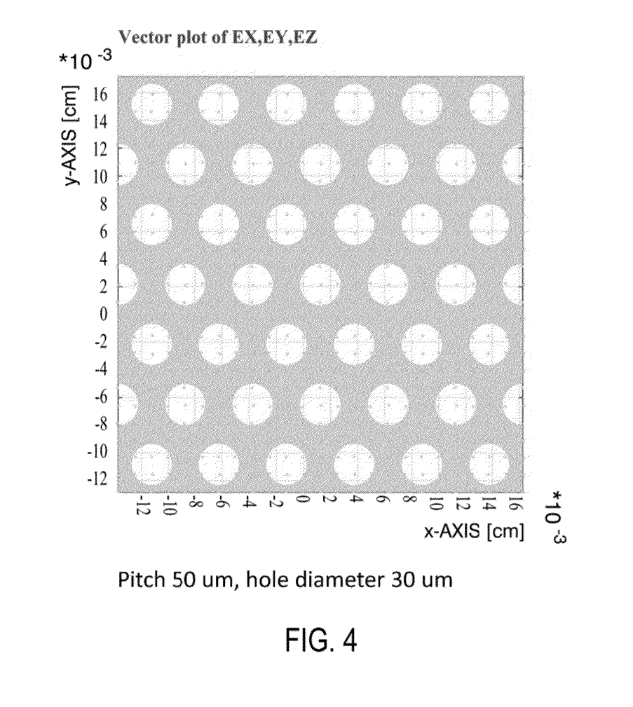

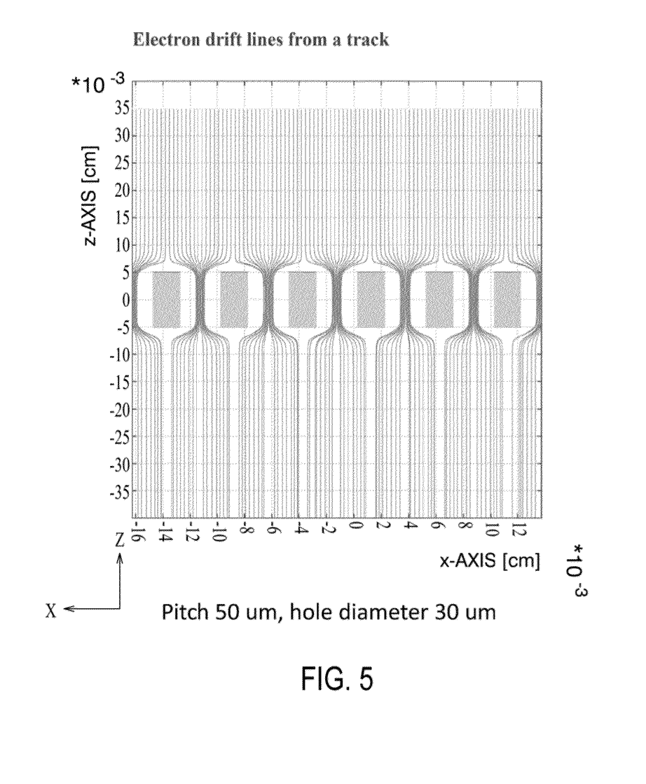

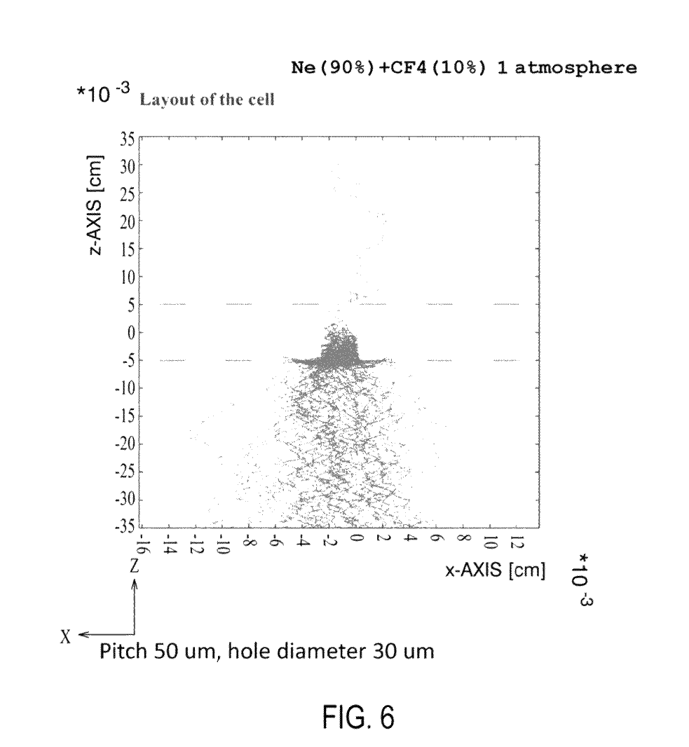

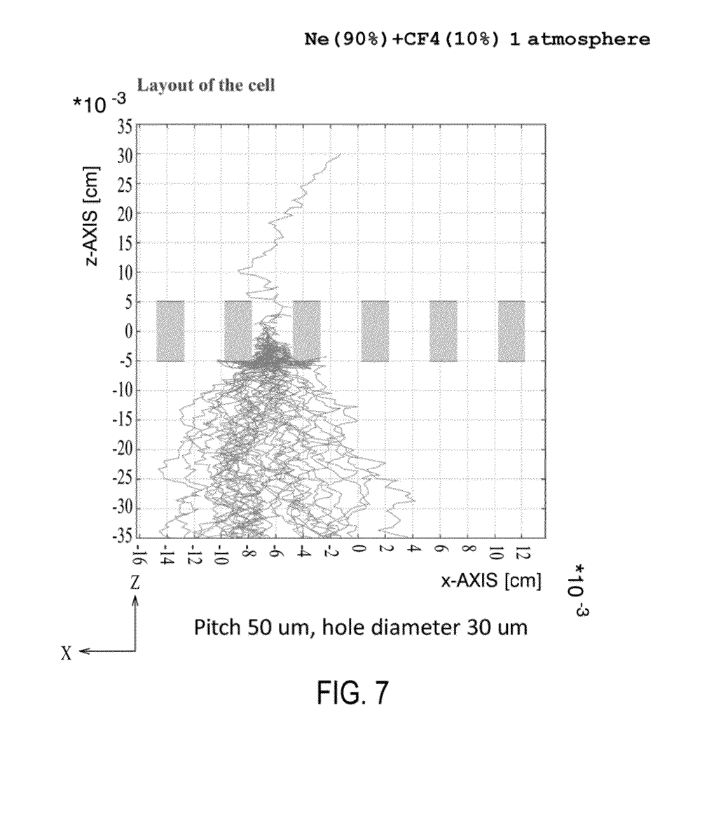

In example 1, as shown in FIG. 4, the following simulation was performed to the electronic multiplier substrate 10, wherein the electronic multiplier substrate 10 was constituted by forming the conductive layers 12 having a thickness of 1 μm on the front and rear surfaces of the electronic multiplier porous glass plate 18. The electronic multiplier porous glass plate 18 has a plate thickness of 100 μm, has the through holes 13 each having a hole diameter of 30 μm and arranged at an arrangement pitch of 50 μm, and has a resolution of 4000 pixels/cm² per unit area. The electronic multiplier substrate 10 having such a structure was placed under an environment filled with a mixed gas of 10% of CF₄ and 90% of Ne at a temperature of 300K, under a pressure of 1 atm, and potential difference of 500V was applied to each conductive layer 12. Then, as shown in FIG. 5, it was found that the electric field was converged in the pore of the through hole 14, and as shown in FIG. 6 and FIG. 7, electrons entered into the pore of the through hole 14 were accelerated to thereby generate the electron avalanche multiplication. Namely, it was confirmed that even when the electronic multiplier porous glass plate 18 having a plate thickness of 100 μm was used, the electron avalanche multiplication could be generated in the pore of the through hole 14.

### Example 2

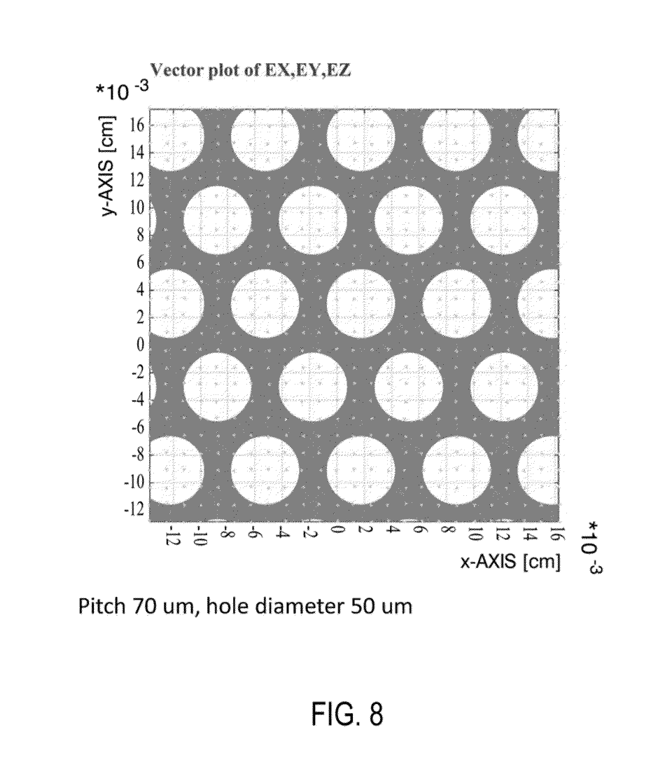

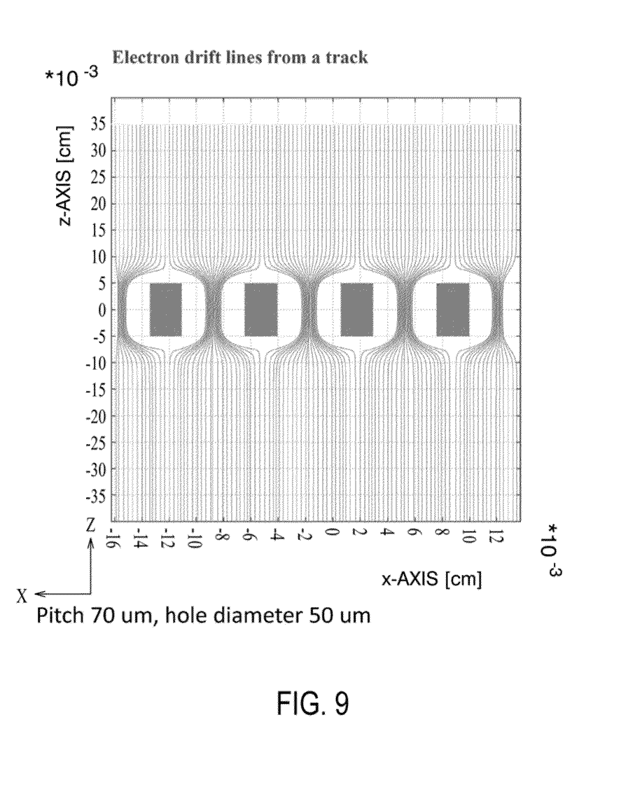

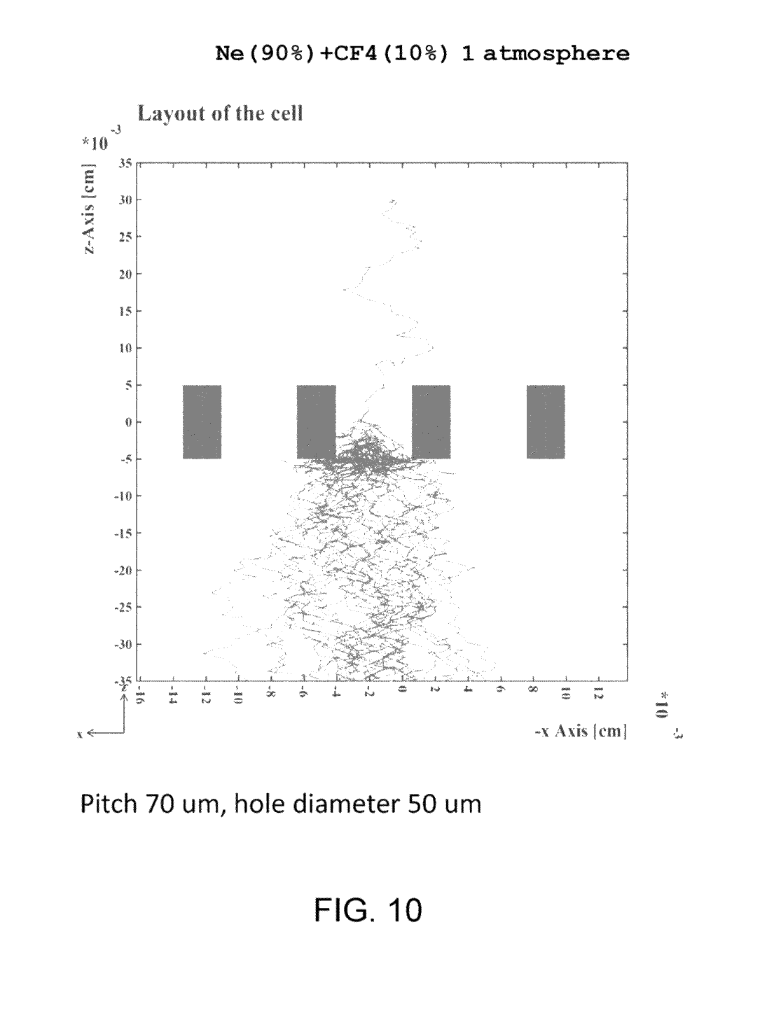

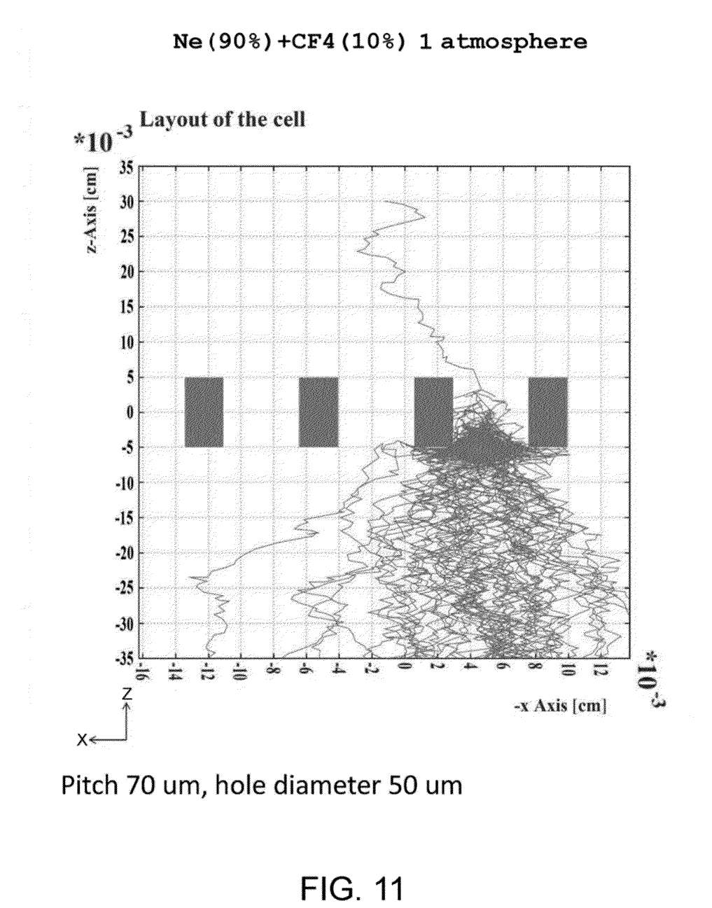

In example 2, as shown in FIG. 8, the following simulation was performed to the electronic multiplier substrate 10, wherein the electronic multiplier substrate 10 was constituted by forming the conductive layers 12 having a thickness of 1 μm on the front and rear surfaces of the electronic multiplier porous glass plate 18. The electronic multiplier porous glass plate 18 has a plate thickness of 100 μm, has the through holes 13 each having a hole diameter of 50 μm, and arranged at an arrangement pitch of 70 μm, and has a resolution of 20408 pixels/cm² per unit area. The electronic multiplier substrate 10 having such a structure was placed under an environment filled with a mixed gas of 10% of CF₄ and 90% of Ne at a temperature of 300K under a pressure of 1 atm, and potential difference of 500V was applied to each conductive layer 12. Then, as shown in FIG. 9, it was found that the electric field was converged in the pore of the through hole 14, and as shown in FIG. 10 and FIG. 11, electrons that enter into the pore of the through hole 14 were accelerated to thereby generate the electron avalanche multiplication. Namely, similarly to the abovementioned example 1, it was also confirmed that even when the electronic multiplier porous glass plate 18 having a plate thickness of 100 μm was used, the electron avalanche multiplication could be generated in the pore of the through hole 14.

### Example 3

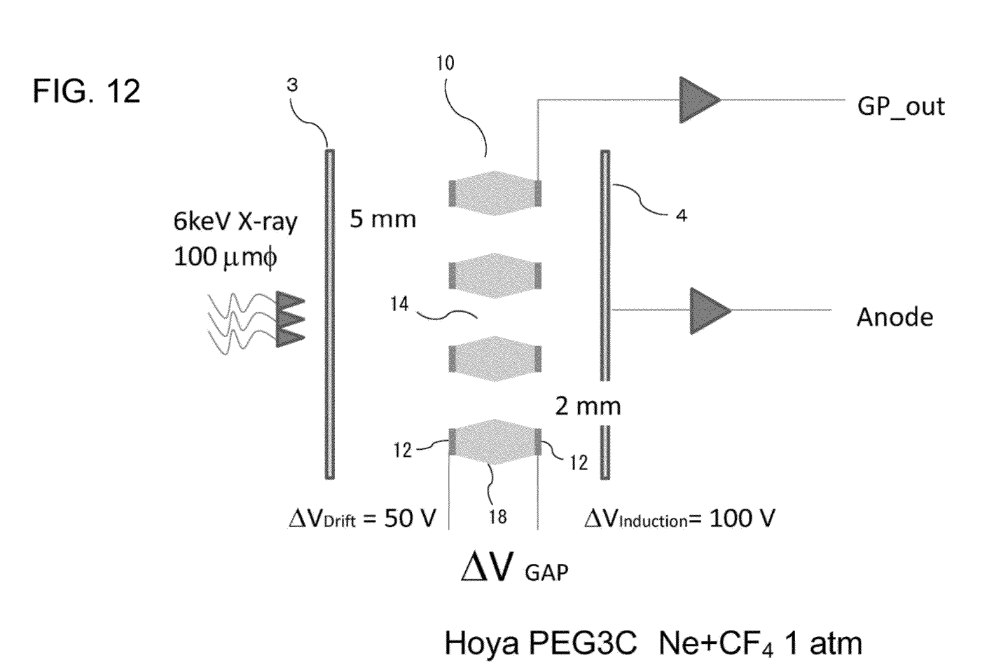

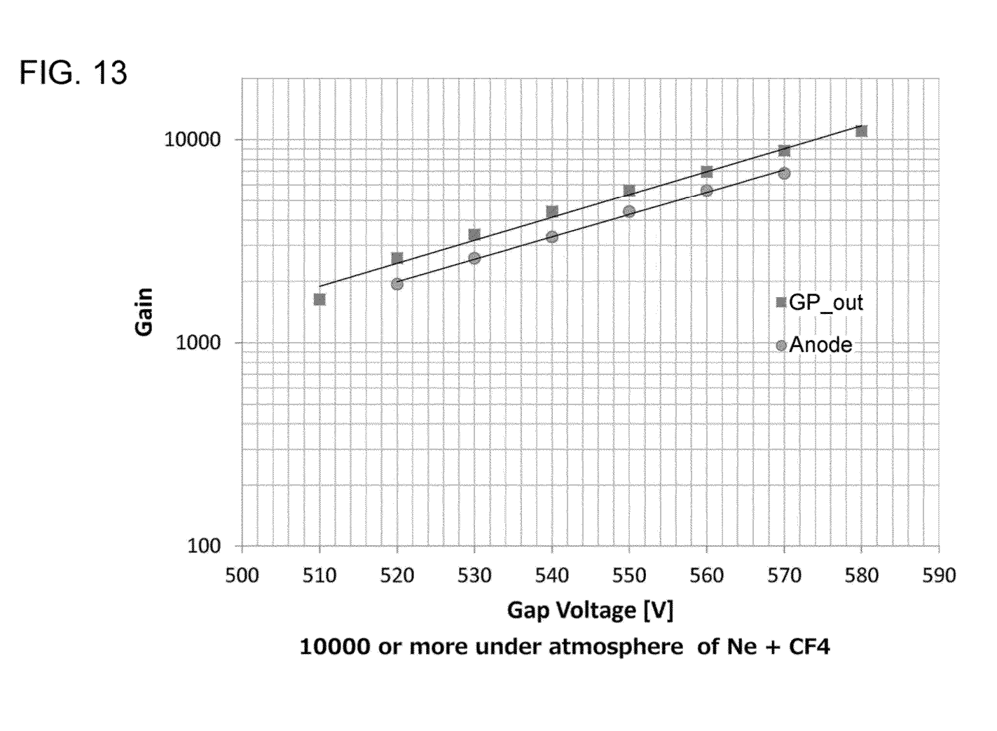

In example 3, as shown in FIG. 12, the electronic multiplier substrate 10 was disposed in the chamber 2 of the detector 1, wherein the electronic multiplier substrate 10 was constituted using the electronic multiplier porous glass plate 18 having a plate thickness of 150 μm, with the through holes 14 having a hole diameter of 100 μm and arranged at an arrangement pitch of 360 μm, and with a resolution of 774 pixels/cm² per unit area. Inside of the chamber 2 was filled with a mixed gas of Ne+CF₄ under pressure of 1 atm, and collimated X-rays of 6 keV were incident thereon at 100 μmφ from an outside radiation source. Further, in the chamber 2, the drift electrode 3 and the electronic multiplier substrate 10 were disposed with an interval of 5 mm between them so that 50V of potential difference ΔV_{induction} was applied thereto, and the electronic multiplier substrate 10 and the readout electrode 4 were disposed with an interval of 2 mm between them so that 100V of potential difference ΔV_{induction} was applied thereto, respectively. Under such a circumstance, gain characteristics were examined during the electron avalanche multiplication at the readout electrode 4 and the conductive layer 12 at the readout electrode 4 side, while variable potential difference (gap potential) ΔV_{GAP} was applied between conductive layers 12 in the electronic multiplier substrate 10. FIG. 13 shows the results thereof. According to the results, it is found that a sufficient gain, namely the electronic multiplication factor of about 10⁴ can be obtained during the electron avalanche multiplication even in a case of only one electronic multiplier substrate 10, if the potential difference ΔV_{GAP} of each conductive layer 12 is about 580 V. Thus, in example 3, the electronic multiplication factor can be 10⁴ or more, although the resolution is deteriorated compared with a case of example 8 described later.

Note that if the photosensitive glass crystallized glass is used as the electronic multiplier porous glass plate 18, a gap-out signal can be obtained from the conductive layer 12 as shown in FIG. 12, due to a higher insulation resistance than that of the glass material such as a soda-lime glass and a heat resistant glass. It can be considered that the gap-out signal is utilized as a trigger signal for indicating a start of a specific operation by the detector 1 for example.

### Example 4

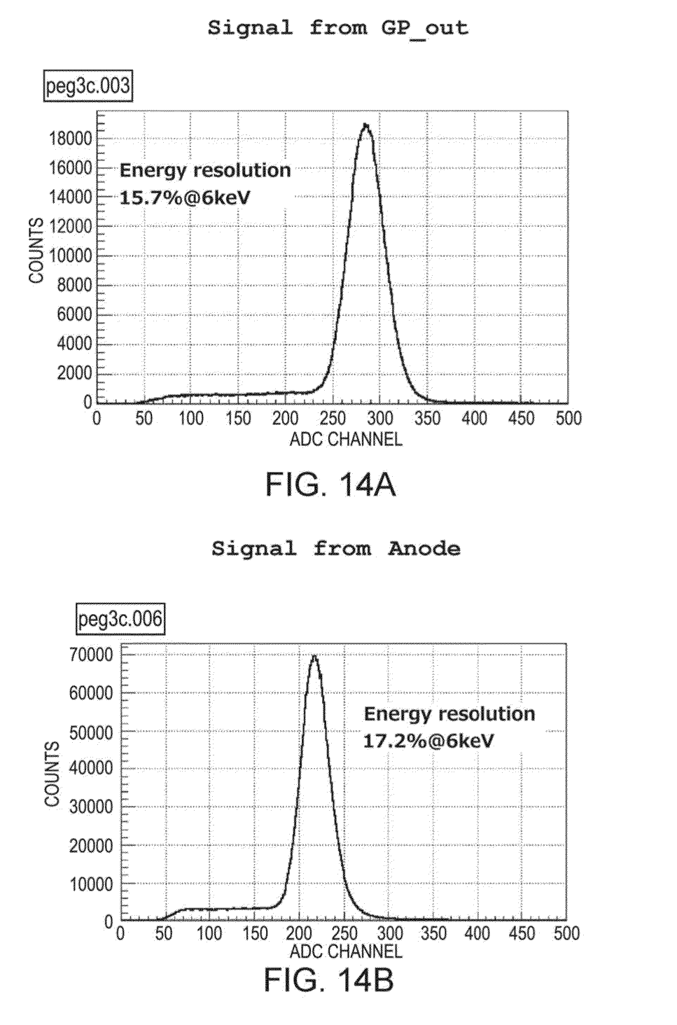

In example 4, potential difference ΔV_{GAP} of each conductive layer 12 is set to about 540V under a circumstance similar to the case of example 3 (see FIG. 12), and an energy resolution was examined at the readout electrode 4 and the conductive layer 12 at the side of the readout electrode 4. Then, the results as shown in FIGS. 14A and 14B were obtained. Wherein, the “energy resolution” means an index of indicating a precision of a radiation energy measurement. If total energy is lost in the detector when the energy of X-rays, etc., is measured, the energy spectrum is principally a line spectrum. However, in an actual detector, the energy spectrum is detected as a distribution spectrum having a certain spread. The energy resolution indicates the spread of the spectrum distribution, and the narrower the spread is, the higher the detection power (precision) is. According to the results of FIGS. 14A and 14B, about 15.7% of the energy resolution is shown by the gap-out signal from the conductive layer 12, and about 17.2% of energy resolution is shown by the anode signal from the readout electrode 4, and it is found that the spread of the spectrum distribution is narrower than a case of using the glass material such as a soda-lime glass, etc., (for example about 23% of energy resolution) and an excellent detection result is obtained. It can be considered that this is because each of the through holes can be made finer by using the photosensitive crystallized glass as the electronic multiplier porous glass plate 18, and no variation, etc., is allowed to occur in the pores so that higher uniformity can be maintained.

### Example 5

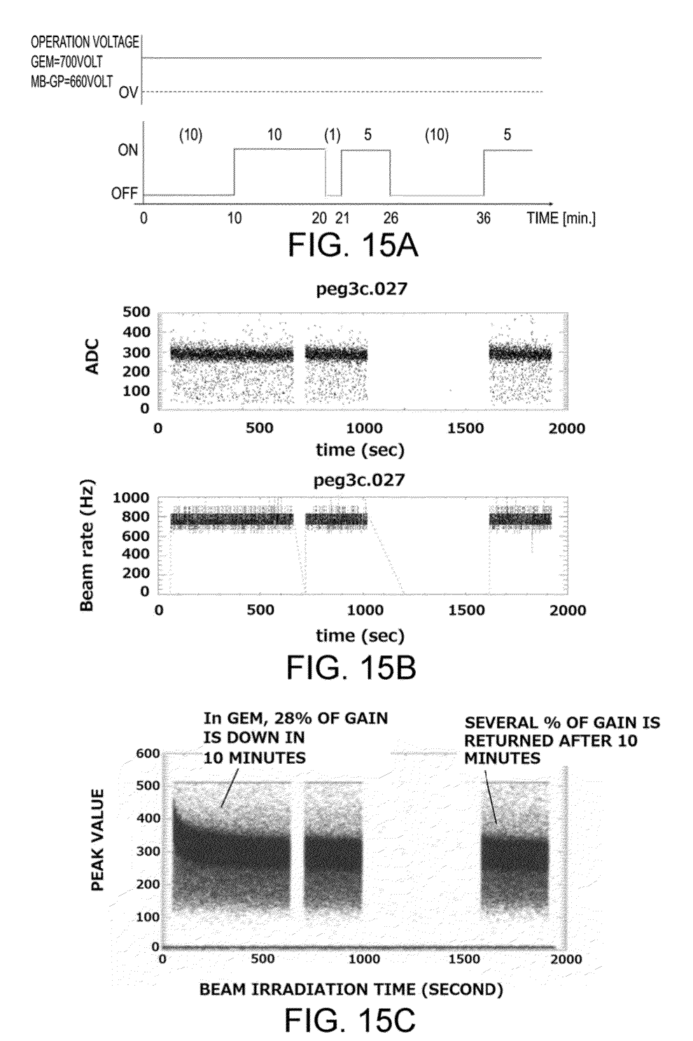

In example 5, potential difference ΔV_{GAP} of each conductive layer 12 was set to about 530V under a circumstance similar to the case of example 3 (see FIG. 12), and on/off of the X-ray irradiation from the radiation source was switched with elapse of the time. In this case, a gain variation was examined with elapse of the time, and as shown in FIG. 15B, it was found that no variation was recognized in a peak value of the gain with elapse of the time. It can be considered that this is because the charge-up of the electronic multiplier substrate 10 can be effectively suppressed. Note that FIG. 15C shows the gain variation with elapse of the time in a case of utilizing a general GEM made of polyimide, for comparison. According to the result thereof, about 28% of gain down is generated in 10 minutes immediately after irradiation, and it can be considered that this is because the charge-up cannot be effectively suppressed unlike a case of using the photosensitive crystallized glass.

### Example 6

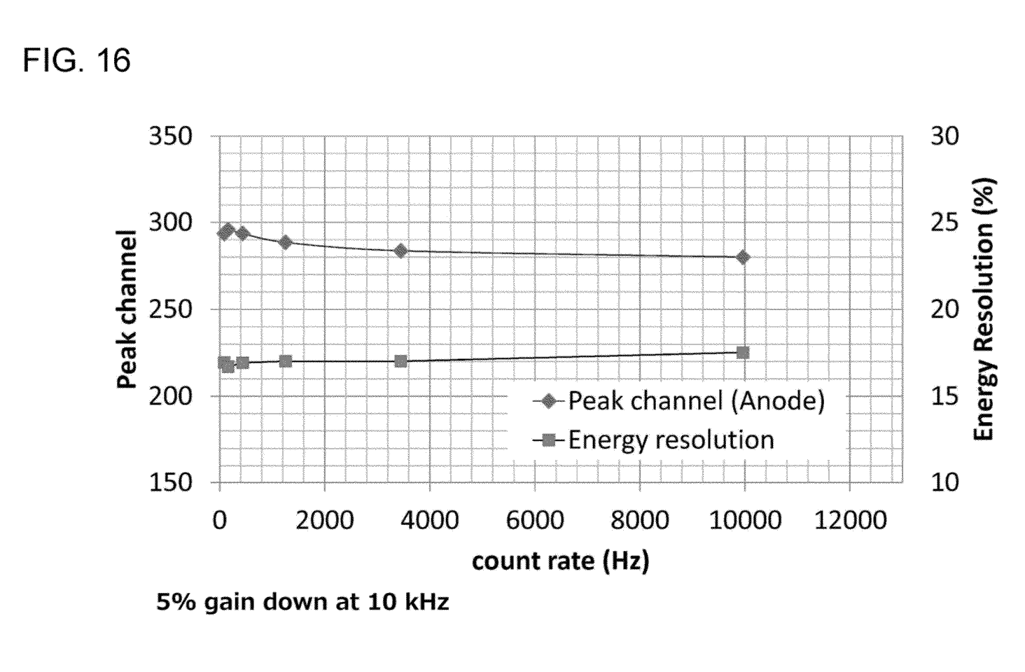

In example 6, potential difference ΔV_{GAP} of each conductive layer 12 was set to about 530V under a circumstance similar to the case of example 3 (see FIG. 12), and an X-ray irradiation rate (Hz) from the radiation source was varied. In this case, a peak channel of the energy spectrum and the energy resolution caused by a variable rate were examined. Then, it was found that the variation by the variable rate was suppressed in any case as shown in FIG. 16. It was found that the reason is that the charge-up of the electronic multiplier substrate 10 could be effectively suppressed, similarly to the case of the abovementioned example 5.

### Example 7

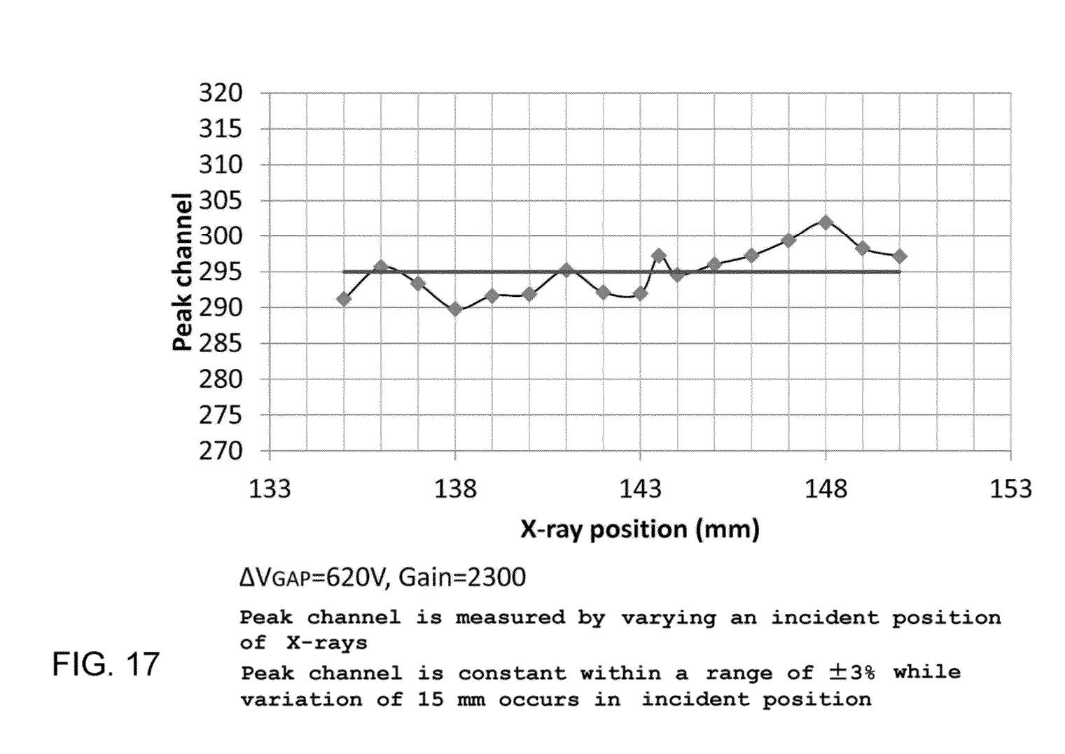

In example 7, potential difference ΔV_{GAP} of each conductive layer 12 was set to about 530V under a circumstance similar to the case of example 3 (see FIG. 12), and a position of the X-ray irradiation from the radiation source was varied. The position here is a planar position of the X-ray irradiation to the electronic multiplier substrate 10. In this case, when the peak channel of the energy spectrum caused by the variation of the X-ray irradiation position was examined, the result as shown in FIG. 17 was obtained. According to the result, it is found that even if the irradiation position of the X-ray is varied, the peak channel is constant within a range of ±3% while variation of about 15 m occurs in the irradiation position for example. It can be considered that this is because each through hole 14 can be made finer and the variation, etc., is not allowed to occur in the pores so that high uniformity can be maintained, by using the photosensitive crystallized glass as the electronic multiplier porous glass plate 18.

### Example 8

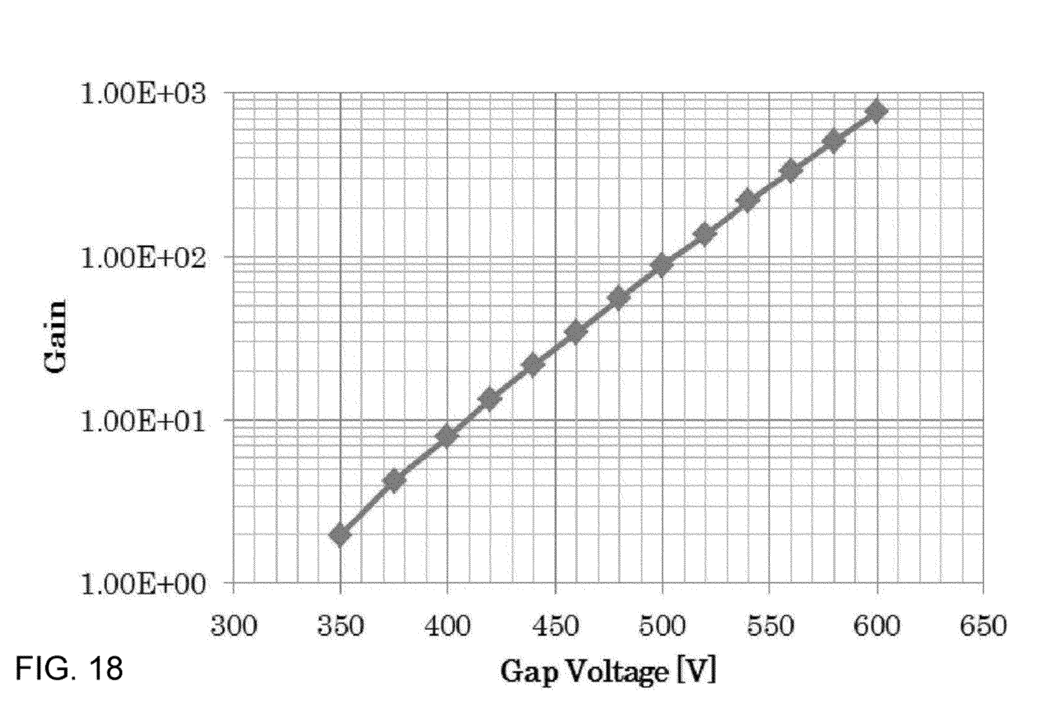

In example 8, the electronic multiplier substrate 10 was disposed in the chamber 2 of the detector 1, using the electronic multiplier porous glass plate 18 having a plate thickness of 130 μm with the through holes 14 having a hole diameter of 50 μm and arranged at an arrangement pitch of 70 μm, and with a resolution of 20408 pixels/cm² per unit area. Inside of the chamber 2 was filled with a mixed gas of Ne+CF₄ under pressure of 1 atm, and collimated X-rays of 6 keV were incident thereon at 100 μmφ from an outside radiation source. Further, in the chamber 2, the drift electrode 3 and the electronic multiplier substrate 10 were disposed with an interval of 5 mm between them so that 50V of potential difference ΔV_{induction} was applied thereto, and the electronic multiplier substrate 10 and the readout electrode 4 were disposed with an interval of 2 mm between them so that 100V of potential difference ΔV_{induction} was applied thereto, respectively. Under such a circumstance, gain characteristics were examined during the electron avalanche multiplication at the readout electrode 4 and the conductive layer 12 at the readout electrode 4 side, while variable potential difference (gap potential) ΔV_{GAP} was applied between conductive layers 12 in the electronic multiplier substrate 10. FIG. 18 shows the results thereof. According to the results, it is found that the electronic multiplication factor of about 10³ is obtained if the potential difference ΔV_{GAP} of each conductive layer 12 is about 600V. According to this example, it is found that the electronic multiplication factor is a high level while maintaining a high resolution at a fine arrangement pitch.

### DESCRIPTION OF SIGNS AND NUMERALS

1 Detector
2 Chamber
3 Drift electrode
4 Readout electrode
10 Electronic multiplier substrate
11 Plate-like member
12 Conductive layer
13 Lamination body
14 Through hole
18 Electronic multiplier porous glass plate

1. An electronic multiplier porous glass plate used for a detector that measures ionized electrons by utilizing an electron avalanche multiplication in a gas, the plate having a plurality of through holes arranged on a plate-like member two-dimensionally,
wherein the plate-like member is formed by a photosensitive crystallized glass obtained by crystallizing a photosensitive glass.

2. The electronic multiplier porous glass plate according to claim 1, wherein the photosensitive crystallized glass has a bending strength of larger than 150 MPa in a non-formation state of the through holes.

3. The electronic multiplier porous glass plate according to claim 1, wherein each of the plurality of through holes has a hole diameter of 100 μm or less.

4. The electronic multiplier porous glass plate according to claim 1, wherein the plurality of through holes are arranged at an arrangement pitch of 400 μm or less.

5. The electronic multiplier porous glass plate according to claim 1, wherein the plate-like member has a plate thickness of 500 μm or less.

6. A detector, comprising:
an electronic multiplier porous glass plate having a plurality of through holes provided on a plate-like member two-dimensionally, wherein the plate-like member is formed by a photosensitive crystallized glass obtained by crystallizing a photosensitive glass;
an electrode having conductive layers formed on front and rear surfaces of the electronic multiplier porous glass plate, and forming an electric field in the through hole by applying a potential difference between the front and rear surfaces; and
a chamber for disposing the electronic multiplier porous glass plate and the electrode in a gas,
wherein ionized electrons are measured by utilizing an electron avalanche multiplication that occurs by the electric field formed in the through holes in the gas.

7. The detector according to claim 6, wherein the photosensitive crystallized glass has a bending strength of larger than 150 MPa in a non-formation state of the through holes.

8. The detector according to claim 1, wherein each of the plurality of through holes has a hole diameter of 100 μm or less.

9. The detector according to claim 1, wherein the plurality of through holes are arranged at an arrangement pitch of 400 μm or less.

10. The detector according to claim 1, wherein the plate-like member has a plate thickness of 500 μm or less.

11. An electronic multiplier substrate, comprising:
an electronic multiplier porous glass plate used for a detector that measures ionized electrons by utilizing an electron avalanche multiplication in a gas, the plate having a plurality of through holes provided on a plate-like member two-dimensionally, wherein the plate-like member is formed by a photosensitive crystallized glass obtained by crystallizing a photosensitive glass; and
an electrode having conductive layers formed on front and rear surfaces of the electronic multiplier porous glass plate, and forming an electric field in the through hole by applying a potential difference between the front and rear surfaces.

12. The electronic multiplier substrate according to claim 11, wherein the photosensitive crystallized glass has a bending strength of larger than 150 MPa in a non-formation state of the through holes.

13. The electronic multiplier substrate according to claim 11, wherein each of the plurality of through holes has a hole diameter of 100 μm or less.

14. The electronic multiplier substrate according to claim 11, wherein the plurality of through holes are arranged at an arrangement pitch of 400 μm or less.

15. The electronic multiplier substrate according to claim 11, wherein the plate-like member has a plate thickness of 500 μm or less.
